(19) United States
(12) Patent Application Publication
(10) Pub. No.: US 2026/0336551 A1
(43) Pub. Date: Oct. 29, 2026

(54) Advanced Driver Assistance System Recalibration Verification System for Sub-Threshold Collision Events

(71) Applicant: Vincent Loccisano, Wellesley, MA (US)

(72) Inventor: Vincent Loccisano, Wellesley, MA (US)

(21) Appl. No.: 19/698,723

(22) Filed: Jun. 4, 2026

(51) Int. Cl. B60R 21/0132; B60W 50/02; B60W 50/04; H04L 9/00

(52) U.S. Cl. CPC B60R 21/01338; B60W 50/0205; B60W 50/04; B60W 2050/0215; H04L 9/50

(57) ABSTRACT

An automated system verifies the integrity of ADAS sensors in vehicles. The system performs its checks autonomously, anywhere, without the need for formal testing boards. It classifies impacts by severity; estimates whether a sensor has been displaced; and calibrates sensors by giving each of them a score based on how accurately they work (“confidence-scoring”). Based on the confidence scores, the system turns ADAS features back on once certain requirements are met, allowing the vehicle to drive itself and make decisions.

### TECHNICAL FIELD

The present invention relates to advanced driver assistance systems (ADAS) and automotive-safety features. More particularly, it relates to an autonomous system for detecting minor vehicular collisions that fall below airbag-deployment thresholds

### BACKGROUND

Passenger vehicles are increasingly equipped with sophisticated sensor networks whose collective, calibrated output forms the basis of Advanced Driver Assistance Systems (ADAS). These sensor networks typically comprise forward-facing cameras; forward-facing short-and long-range radar units; rear-facing cameras; rear-lateral radar units that monitor blind spots; light-detection and ranging (LiDAR) units; ultrasonic proximity sensors; and inertial measurement units (IMUs). Each sensor is factory-calibrated to known parameters. These include the sensor's spatial position, rotational orientation, and field-of-view relative to a common vehicle-coordinate reference frame, as well as lens-distortion coefficients and gain profiles.

The calibration accuracy of these sensors is not merely a performance parameter; it is a functional safety prerequisite. Research by National Highway Traffic Safety Administration (NHTSA) determined that even minor sensor misalignment (that which is insufficient to cause visible vehicle damage) may produce:
Asymmetric Lane-Departure Warning (LDW) behavior, causing the system to respond preferentially to lane markings on one side;
Degraded Automatic Emergency Braking (AEB) response-timing, which reduces brake-initiation distance;
And, at misalignment angles that are undetectable through visual inspection, complete Lane-Keeping Assist (LKA) system failure.

In the absence of calibration, or when calibration has degraded, ADAS features may fail to activate when needed, or they may activate falsely, creating nuisance events which erode driver trust, or causing dangerous driver over-reliance on a faulty system.

Existing vehicle-safety architectures address major collisions through a well-established protocol chain: airbag deployment sequences triggered at impact energies typically above eight to 25 G, depending on deployment zone; post-crash electrical system isolation; hazard-light activation; and emergency-service notification via embedded telematics. This protocol chain is specifically designed for high-energy collisions, i.e., those that cause structural damage and occupant injury.

Collisions increasingly occur at impact energies below airbag-deployment thresholds. These types of collisions physically displace ADAS sensor components. Falling within this sub-threshold range are events like parking-lot impacts; low-speed rear-end collisions at intersection stops; minor curb-strikes during parking maneuvers; fender contacts in congested urban traffic; and impacts with road debris or fixed objects at moderate speeds. Events like these can permanently displace sensor mounting brackets, or shift camera housings along their mounting rails, or deform RADAR-bearing fascia panels that alter antenna boresight angles, or modify vehicles in ways that change the angles at which sensor units observe the world —yet they trigger no existing safety protocol, and leave no record.

Industry data compiled from insurance-appraisal records show that ADAS calibrations were required in 23% of all repairable insurance appraisals in 2025, compared to less than one percent in 2017. This growth is attributable to ADAS-equipped vehicles entering vehicle fleets. This is expected to increase as AEB becomes mandatory equipment under NHTSA Federal Motor-Vehicle Safety Standard (FMVSS) 127, which requires automatic emergency braking on all new US passenger cars and light trucks from model year 2029.

ADAS systems often do not perceive low-impact events that fall below an ADAS threshold—a parking-lot door-ding; a low-speed rear-bump; a scrape. Instead, the system trusts the calibration parameters of its factory settings, and applies them unconditionally. The system has no mechanism for verifying these values against the reality of a low-impact event. As a result, the vehicle's sensor suite is no longer calibrated to specification. A driver may subsequently re-engage ADAS features (such as hands-free highway driving modes) while unaware that stored calibration values have not accounted for the impact event.

Current solutions to the ADAS calibration problem universally require external shop setups and human expertise. Static calibration procedures, the prevailing industry standard, require placement of calibration targets—patterned panels, retroreflective markers, or laser-emitting fixtures—at precise, manufacturer-specified distances and orientations in front of the stationary vehicle; in a level indoor space with controlled lighting; performed by trained technicians using manufacturer-proprietary diagnostic software. Dynamic calibration procedures, used as a supplement or alternative for some sensor types, require driving the vehicle through specific maneuver sequences on roads with defined lane markings. Both approaches require shop visits that take hours, incur costs can cost several hundred dollars per calibration event, and take up the mechanics' time. Further, 70% of collision shops in the United States lack the in-house equipment, space, or training to perform ADAS calibrations that comply with OEM standards. The consequence is systematic under-calibration of the ADAS-equipped vehicles that have suffered minor collisions, compromising safety.

There remains a need for a system and method that:
Detects particular impact events as a triggering mechanism, i.e., an event that starts the system's series of checks;
Does so autonomously, anywhere, without the need for formal testing boards;
Verifies that all sensors are communicating correctly and consistently as they process natural scenes (e.g., trees, signs, buildings);
Calibrates sensors by giving each sensor a score based on how accurate it seems (“confidence-scoring”);
Turns features back on once a certain requirement is met, allowing the vehicle to drive itself and make decisions (referred to as “gated autonomous authority restoration”), based on the confidence scores;
Does this without the need for external targets, shop infrastructure, or human intervention.

In this disclosure, the term “extrinsic calibration parameters” refers to where a sensor unit resides on a vehicle, and where it is pointed, relative to a defined reference frame. The reference frame is what was stored in the vehicle's ADAS compute module in the factory, or at last professional recalibration. The terms “calibration displacement” and “sensor displacement” refer to physical changes in these parameters, as caused by mechanical events that alter the sensor's mounting position or orientation.

A state machine is a conceptual model used by programmers and engineers to design systems that have a specific set of conditions, or “states.” In this model, a system can be in only exactly one state at a time, changing from one state to another according to rules and inputs.

Each reference to “computer” is meant to include computers that have non-volatile storage, i.e., a computer part that remembers its data after it has been powered off. “Non-volatile storage module” is another term for this.

### SUMMARY

An automated system verifies that a vehicle's ADAS sensors are communicating correctly and consistently; verifies the integrity of ADAS sensors in vehicles; and performs its checks autonomously, anywhere, without the need for formal testing boards. It classifies impacts by severity; estimates whether a sensor has been displaced; and calibrates sensors by giving each of them a score based on how accurately they work (“confidence-scoring”). Based on the confidence scores, the system turns ADAS features back on once certain requirements are met, allowing the vehicle to drive itself and make decisions.

The impact-severity and sensor-risk classifier continuously monitors accelerometer and inertial-measurement-unit (IMU) data from the vehicle's sensor network. When it detects an acceleration pulse that is within a particular threshold, the classifier gathers data to compute a risk score for each ADAS sensor.

The detection threshold is defined as one that exceeds lower-trigger thresholds, but falls below an airbag-deployment threshold.

To compute the risk score, (or Displacement Risk Score (DRS)), the classifier considers impact magnitude, direction vector, and pulse shape. It multiplies the impact vector against a pre-stored Structural Vulnerability Profile (SVP) for each sensor. Sensors whose DRS exceeds a configurable threshold are classified as high-risk, and are queued for calibration-integrity verification.

Once a vehicle is restarted, the system automatically checks to see if any vital sensors have been bumped out of place. It does this quickly while driving, without needing a mechanic or special calibration equipment. Using naturally occurring environmental scenes observed by the vehicle's sensors during normal driving, the estimator compares data from multiple sensors to ensure their views of the surroundings align. This is referred to as a “cross-sensor reprojection-consistency analysis.” It also checks whether its camera is correctly aligned by viewing painted lane lines on the road; by using perspective to see where the lines meet on the horizon; and whether that meeting point is off-center. These checks determine whether the camera got displaced in an impact, and it is also referred to as “road-feature-based extrinsic verification using lane markings and vanishing-point geometry.” The system also uses temporal evidence-accumulation to distinguish systematic sensor displacement from random measurement noise; i.e., it watches data for a short duration to ensure the sensor has actually been displaced, not just showing a temporary reaction to a random event.

The confidence-scoring engine synthesizes the outputs of the sensor-displacement estimator into a Calibration Confidence Score (CCS) for each verified sensor. This is expressed as a probability: that the sensor's stored extrinsic calibration parameters remain within manufacturer-defined, operational tolerance. The CCS is computed using a calibrated scoring function that maps the multi-dimensional evidence vector to a probability, classified into categories of: PASS (CCS≥0.85), ADVISORY (0.60≤CCS<0.85), or FAIL (CCS<0.60)

An autonomous, authority-gating module enforces ADAS feature availability based on the above CCS vector. It uses feature-to-sensor dependency mapping to determine which features are affected by the confidence scores of specific sensors. Features that depend on FAIL-band sensors are disabled. Features that depend on ADVISORY-band sensors are available, but at reduced authority. Features whose dependent sensors all score in the PASS band are fully restored. The driver receives a per-sensor status summary and per-feature availability report through the vehicle's HMI. If any sensor receives an ADVISORY or FAIL classification, a service notification is transmitted to the vehicle's telematics channel.

This combination of safety features offers a unified, post-collision safety workflow that is integrated into the vehicle's on-board computing architecture, without requiring external infrastructure.

### DESCRIPTION

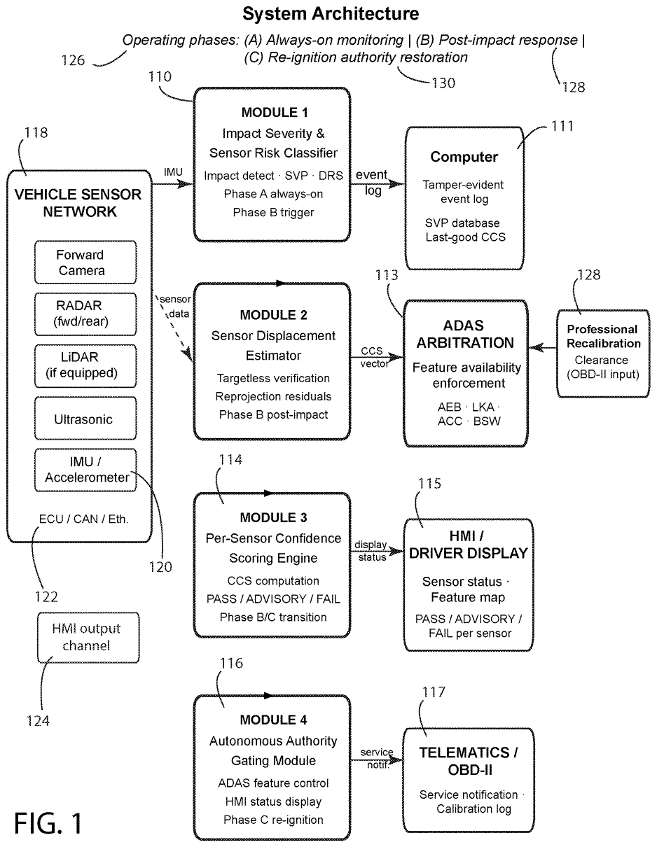

FIG. 1 is a diagram of the system architecture.

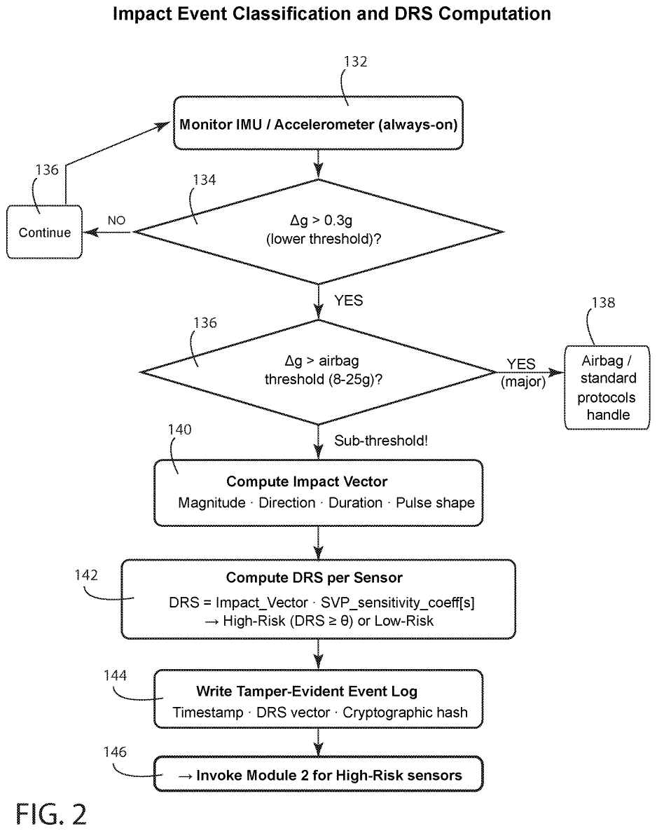

FIG. 2 is a flowchart of the modules and an event-logging workflow.

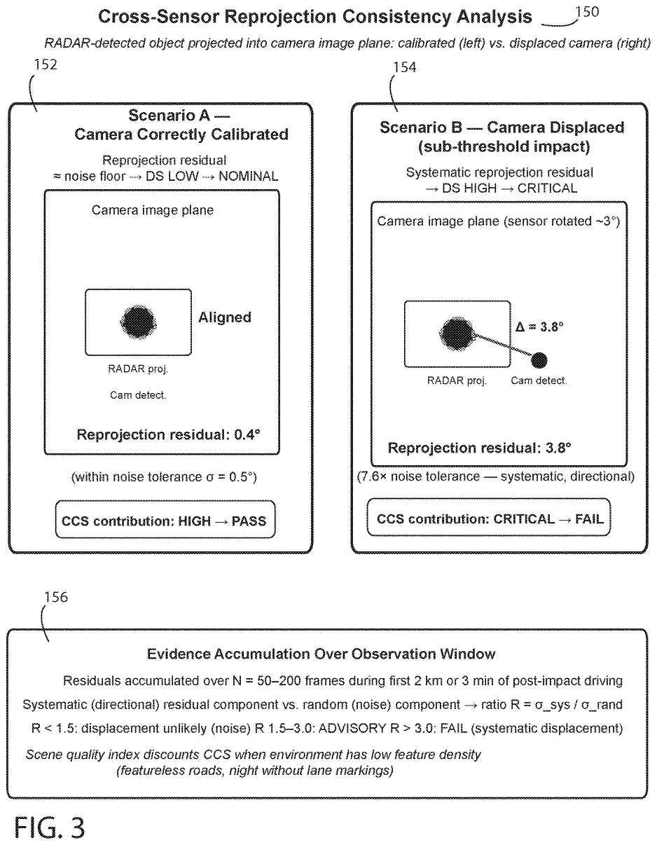

FIG. 3 illustrates a cross-sensor reprojection consistency analysis.

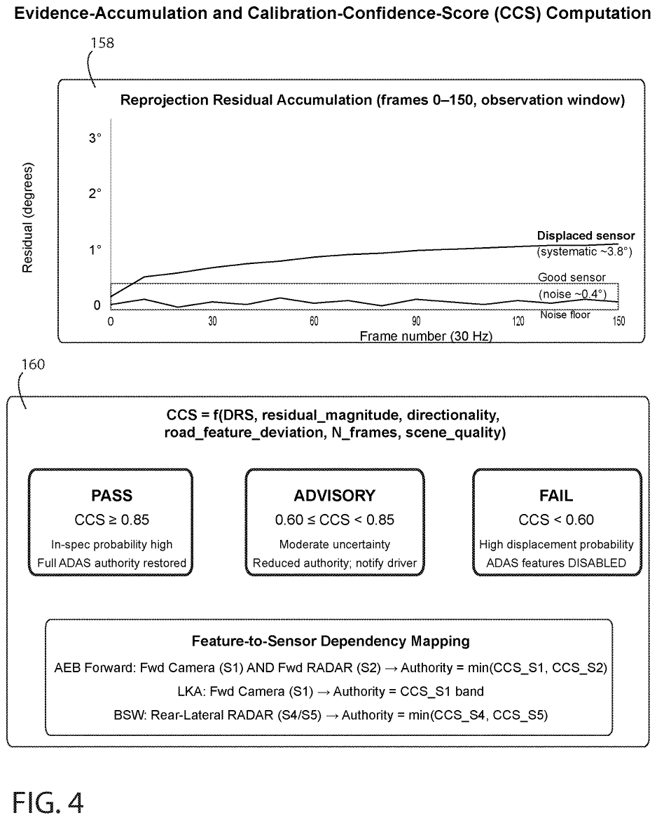

FIG. 4 is a diagram showing a calibration-confidence-score (CCS) computation workflow.

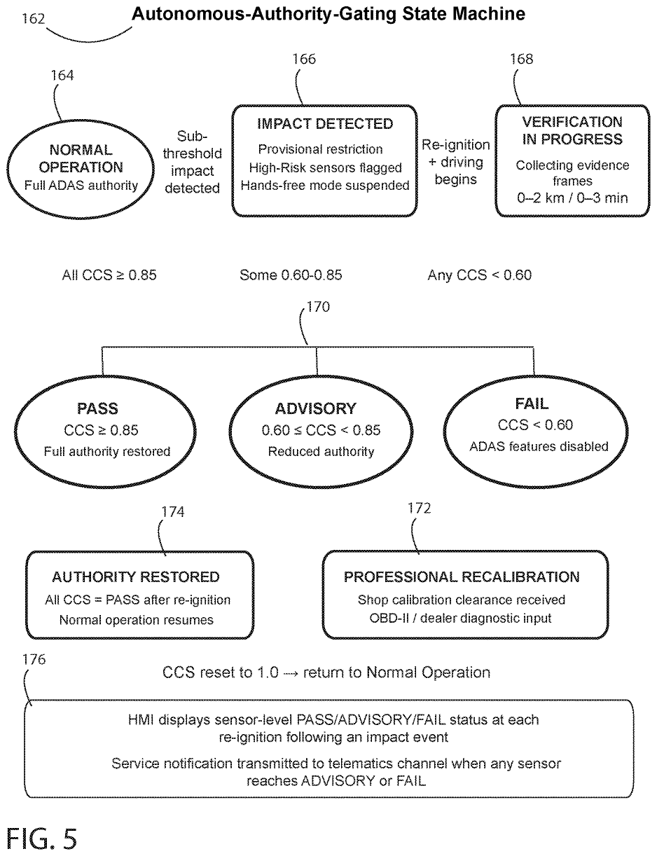

FIG. 5 is a diagram of the system's state machine.

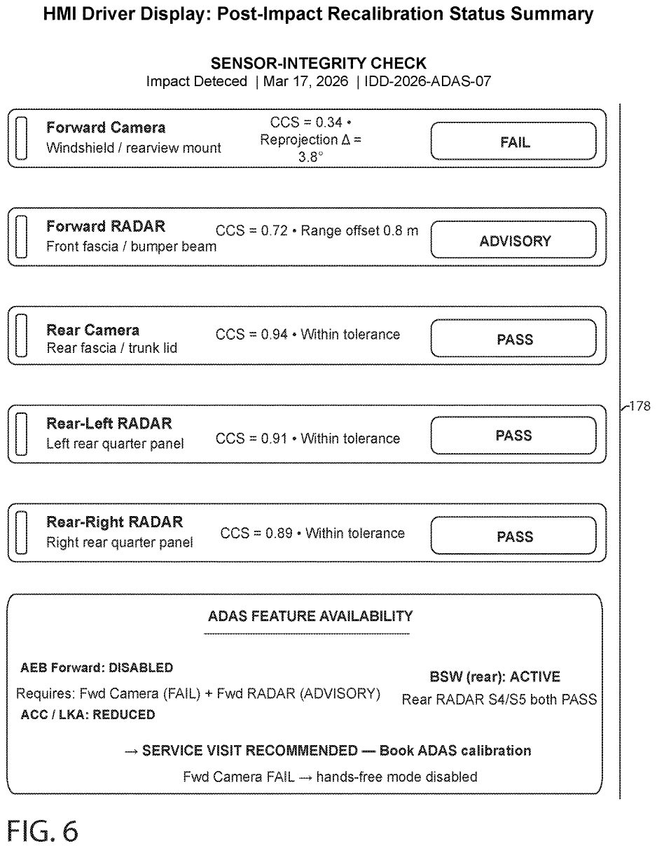

FIG. 6 shows a graphical user interface of a driver-facing display.

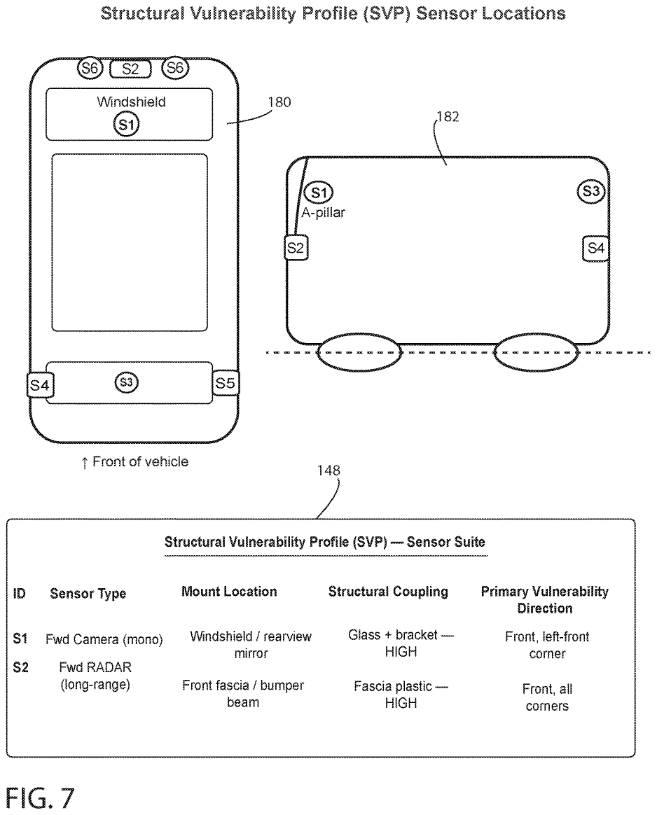

FIG. 7 is a schematic showing the system's sensors on a representative vehicle.

### DETAILED DESCRIPTION

FIG. 1 shows four modules of the invention: Impact Severity and Sensor Risk-Classifier (Module 1) 110, Sensor Displacement Estimator (Module 2) 112, Per-Sensor Confidence Scoring Engine (Module 3) 114, and Autonomous Authority Gating Module (Module 4) 116 and (FIGS. 5, 162).

Each module is a software process executing on the vehicle's central domain controller (the ADAS compute module). The system has access to raw sensor data streams from all ADAS sensors in the vehicle's sensor network 118, as well as to the vehicle's IMU and accelerometer network 120; the vehicle's electronic-control unit (ECU) network 122 (via Controller Area Network (CAN) bus or Automotive Ethernet); and to the human-machine interface (HMI) output channel 124. The system does not require external network connectivity, cloud processing, or hardware modifications beyond the resident ADAS sensor suites.

The system operates in three phases. Phase A 126 is an “always-on,” background, monitoring phase during normal vehicle operation. In this phase, Module 1 continuously observes accelerometer and IMU data without consuming significant compute resources.

During Phase A, an Impact-Severity and Sensor-Risk Classifier (Module 1) 110, continuously monitors the output of the vehicle's accelerometer and IMU network. The monitoring algorithm executes on the ADAS domain controller's real-time processing core at a sampling rate of at least one hundred hertz to capture the full temporal profile of impacts.

Phase B 128 is an impact-event response phase. It is triggered when Module 1 detects a qualifying impact. Modules 2 and 3 then execute a workflow that computes a confidence score. Phase C 130 is a “re-ignition authority restoration phase” in which Module 4 makes ADAS features available according to the most recently computed CCS vector, and reports the status of calibration integrity.

A computer 111 stores a Structural Vulnerability Profile (SVP), an impact-event log, and a CCS history for each sensor in the ADAS. The impact event log is maintained as a tamper-evident chain of cryptographically hashed records, with each record comprising a timestamp, an impact-severity classification, an impact-direction vector, and resulting DRS vector for each sensor.

An ADAS arbitration layer 113 enforces feature availability. The driver receives a status summary for each sensor and availability report through the vehicle's HMI 115. If any sensor receives an ADVISORY or FAIL classification, a service notification is transmitted to the vehicle's telematics channel 117.

Modules have three operating phases: Always-on monitoring 126 (Module 1); Post-impact response 128 (Modules 1, 2, and 3); and, in Module 4, a re-ignition authority restoration 130.

FIG. 2 shows the workflow of Module 1 (FIGS. 1, 110). The system monitors the IMU and accelerometer 132 and decides a threshold 134. A low-threshold impact is defined by the following criteria: (a) a peak acceleration delta magnitude, computed as the peak absolute change in acceleration magnitude over a rolling fifty-millisecond window, exceeding a lower trigger threshold ΔG_lower, nominally configurable at 0.3 g; (b) the same peak acceleration delta not exceeding an upper threshold ΔG_upper nominally set at the airbag deployment threshold x for the applicable deployment zone, typically in the range of eight to twenty-five g (depending on the vehicle's airbag deployment zone geometry and angle); and (c) a pulse duration and shape profile consistent with a vehicular impact event, as distinguished from road-surface events by a pulse-shape analysis algorithm.

If not found to be of lower threshold, the system continues monitoring. if ΔG is above an airbag threshold (8-25 g), 136, it proceeds to airbag/standard protocol 138. If below that threshold, it computes impact vector 140, and then computes DRS per sensor 142, and then writes to a tamper-evident log 144, and then invokes module 2 146 for high-risk sensors.

The pulse-shape analysis computed in step 140 distinguishes vehicular impacts from road-surface events including pothole impacts and curb drops by analyzing the temporal derivative of the acceleration signal. Vehicular impacts characteristically produce a single-peak or multi-peak pulse with a rise time between five and fifty milliseconds. Road-surface events characteristically produce sharper impulse profiles with shorter rise times and different harmonic frequency content. The pulse shape classifier operates on a feature vector comprising rise time, peak width at half maximum, and a frequency-domain feature derived from a short-time Fourier transform of the acceleration signal in the 5-200 Hz band.

Upon detection of a qualifying event, a classifier in step 140 computes the impact-direction vector by analyzing acceleration signal components across the vehicle's three linear acceleration axes and two rotational axes available from the IMU. The direction vector identifies the primary face of the vehicle that received the impact energy (front center, front-left corner, front-right corner, rear center, rear-left corner, rear-right corner, left side, right side) and the elevation angle of the impact relative to the vehicle's horizontal plane.

Each ADAS sensor in the vehicle's sensor suite is associated with a pre-stored Structural Vulnerability Profile (SVP) 148 maintained in the computer. The SVP for each sensor encodes four fields: the sensor's mounting location on the vehicle body, expressed as a location class selected from a defined enumeration of vehicle body zones; the sensor type, selected from camera, short-range RADAR, long-range RADAR, LiDAR, and ultrasonic; the sensor's structural coupling classification reflecting how directly the sensor mount is connected to the primary impact load path of the vehicle body; and a directional sensitivity coefficient vector k[s, d] expressing, for each impact direction d, the expected calibration displacement magnitude per unit of impact energy delivered to the vehicle from direction d, expressed in degrees of rotational displacement per g of peak impact acceleration.

A Structural Vulnerability Profile (SVP) table (FIGS. 7, 148) lists location, sensor type, structural-coupling classification, and vulnerability direction for each sensor.

The SVP's parameters for six sensors (S1-S6) are stored in an SVP database. Forward cameras mounted on brackets behind windshields receive high-directional sensitivity coefficients for front-impact directions. This is enabled by the compliant structure of windshield glass as well as the lever-arm effect of windshield mounting. RADAR units x mounted on front or rear fascia panels receive high-sensitivity coefficients for a corresponding impact face. Direct, structural coupling between the fascia and the RADAR mounting flange enable this.

The Displacement Risk Score (DRS) for sensor s is computed as

DRS[s]=∥k[s, d_impact]×ΔG_peak∥
where d_impact is the detected impact direction class;
ΔG_peak is the peak acceleration delta;
and k[s, d_impact] is the sensitivity coefficient for sensor s in direction d_impact.

Sensors whose DRS[s] exceeds a configurable threshold θ_DRS, nominally 0.5, are classified as high-risk and added to the pending-verification queue. Sensors whose DRS[s] falls below θ_DRS are classified as low-risk, and assigned a provisional, unchanged CCS, pending outcome of Phase B verification.

The following data are written synchronously to the computer's 500 tamper-evident event log:
Impact event
Its severity classification
The computed impact direction vector
Peak acceleration delta
Resulting DRS vector for each sensor.

Each log entry is structured as a fixed-format record comprising:
A sequence number enforced by the ADAS;
A UTC timestamp synchronized to GNSS time at the most recent vehicle-ignition cycle;
Vehicle identification number (VIN) hash;
The impact-severity class;
The impact-direction vector;
ΔG_peak;
DRS vector for all sensors.

The log entry is finalized with a SHA-256 cryptographic hash of its contents concatenated with the hash of the preceding log entry, maintaining an append-only hash chain that enables detection of modifications to the event history.

FIG. 3 shows the system's cross-sensor reprojection analysis 150, which is performed by Module 2. Using naturally occurring environmental scenes observed by the vehicle's sensors during normal driving, the estimator compares data from multiple sensors to ensure each of their views of the surroundings align. Two scenarios are compared. Scenario A 152 shows a correctly calibrated camera with RADAR-to-camera projection alignment. This is compared to Scenario B 154, in which a physically displaced camera produces systematic reprojection residuals. Over a duration (an “observation window”) (FIGS. 4, 159), evidence is accumulated using a method as illustrated in 156. This is described in more detail below.

The Sensor Displacement Estimator (Module 2) (FIGS. 1, 112) is invoked for each sensor in the High-Risk queue following vehicle re-ignition at the next use of the vehicle after an impact event. Module 2 executes a targetless, field-deployable verification routine that uses naturally occurring environmental scene features observed during the first portion of normal driving following re-ignition to assess whether each High-Risk sensor's stored extrinsic calibration parameters remain consistent with the sensor's current physical orientation and position on the vehicle.

The observation window for Module 2 is bounded 156 (and FIGS. 4, 159); the module collects evidence for a maximum of two kilometers of vehicle travel, or three minutes of elapsed driving time from re-ignition, whichever is shorter. This bounding ensures that the verification result is quickly available to the driver, and that the provisional restriction imposed during Phase B does not persist indefinitely under edge-case conditions. During the observation window, the vehicle operates under provisional ADAS restrictions: features dependent on High-Risk sensors are limited to their most conservative authorized mode (nominally SAE Level-1 driver assistance requiring driver hands on wheel), with higher authority modes suspended, pending the verification outcome.

For vehicle sensor configurations that include overlapping fields of view between two or more sensors—a characteristic of all current-generation mass-market ADAS platforms that have at least a forward camera and a forward RADAR—Module 2 performs a cross-modal reprojection consistency analysis FIGS. 4, 158 as its primary verification method.

For forward-camera and forward-RADAR configurations, the estimator projects RADAR-detected objects into the camera image using the stored camera-RADAR extrinsic transform. For each RADAR detection that can be matched to a camera detection by velocity-range proximity, within a configurable spatial-gating window, the angular offset between the projected RADAR centroid and the camera-detected centroid is computed as a reprojection residual. A correctly calibrated camera will produce reprojection residuals distributed around zero with a standard deviation reflecting the combined noise levels of the camera and RADAR—nominally less than 0.5 degrees in angular offset for a well-calibrated forward-sensor pair. A physically displaced camera will produce reprojection residuals with a non-zero mean and directional consistency: the residuals will systematically point in the same direction across multiple, independent observations, reflecting the fixed angular offset introduced by the displacement.

For stereo-camera configurations, the disparity map consistency is analyzed on naturally occurring edge features including lane marking edges, vehicle contours, and horizon-line features. The expected disparity for each tracked feature is computed from the stored stereo baseline and calibration parameters and compared to the measured disparity. Systematic disparity errors—deviations that are consistent in magnitude and direction across multiple features—indicate displacement of one camera relative to the other.

For vehicles equipped with LiDAR, the estimator additionally performs LiDAR-to-camera surface normal consistency analysis. For co-observed planar surfaces such as vehicle sides, lane-adjacent barriers, and building facades, the surface normal vector estimated from the LiDAR point cloud is compared to the surface normal vector derived from camera-based edge gradient analysis. Consistent angular deviations between LiDAR-derived and camera-derived surface normals at multiple independent surface patches indicate displacement of one sensor relative to the other.

To distinguish systematic sensor displacement from random measurement noise, the system performs road-feature-based extrinsic verification using lane markings and vanishing-point geometry, as well as temporal evidence-accumulation.

As a complementary verification method, Module 2 (FIGS. 1, 112) uses the vehicle's own motion—derived from wheel odometry, IMU measurements, and where available, GNSS position—to perform structure-from-motion analysis on road features that are detected by each camera sensor. The camera pose implied by the structure-from-motion analysis over a sequence of frames is compared to the stored extrinsic calibration parameters. Deviations in the estimated pitch, yaw, roll, or translational offset exceeding configurable tolerances—nominally 0.5 degrees in any rotational axis and 5 mm in any translational axis—constitute independent evidence of sensor displacement.

Road features used for this analysis include lane-marking geometry, where illumination and lane-marking quality permit; the horizon-line angular position in the camera image, which is deterministically related to camera-pitch angle; and the vanishing-point convergence angle of parallel road features such as lane markings and road-edge features, which is deterministically related to camera-yaw angle. These features are available in the majority of daytime driving environments as well as many nighttime environments with adequate road illumination, providing robust evidence coverage across the two-kilometer observation window.

FIG. 3 and FIG. 4 illustrate the system's temporal-evidence-accumulation and systematic-to-random ratio computation. Individual frames of cross-modal reprojection analysis may be affected by transient factors such as: momentary sensor occlusion; frame-synchronization jitter; object-tracking association errors; and environmental reflections. Addressing this, module 2 (154 and FIGS. 1, 112) accumulates reprojection residuals across all frames in the observation window 158 rather than relying on single-frame evidence. The accumulated residual distribution for each sensor pair is analyzed to compute a systematic-to-random ratio R, defined as the ratio of the estimated systematic (directionally consistent) component of the residuals to the estimated random (noise-attributable) component.

The systematic component is estimated as the mean of the residual vector distribution; the random component is estimated as the standard deviation. A correctly calibrated sensor pair will produce residuals with a mean near-zero and a standard deviation near the sensor noise floor, yielding R values typically below 1.0. A displaced sensor will produce residuals with a non-zero mean, reflecting the displacement, yielding R values proportional to the displacement magnitude relative to sensor noise. The systematic-to-random ratio R serves as the primary input to the computation (FIGS. 3, 152 and 154) in Module 3, along with the absolute magnitude of the systematic residual component, the number of evidence frames accumulated, and the scene quality index.

A scene-quality index is a co-estimated variable that reflects the quality of evidence available in the observation window's environment 156. Low scene-quality conditions 156 (featureless motorway segments without lane markings; night-driving without adequate road illumination; heavy precipitation that redueces sensor detection range) reduce the reliability of the evidence gathered. When the scene-quality index falls below a configurable threshold, the CCS computation (FIGS. 3, 152 and 154) discounts the evidence and may defer the verification decision to the next ignition cycle, maintaining the provisional restriction rather than issuing a potentially unreliable PASS.

FIG. 4 illustrates reprojection residual accumulation over the observation window and the CCS computation workflow (FIGS. 3, 152, 154), including the three CCS classification bands (PASS, ADVISORY, FAIL) and the feature-to-sensor dependency mapping used by Module 4.

The Sensor Confidence Scoring Engine (Module 3) synthesizes multi-dimensional evidence vector produced by Module 2 for each High-Risk sensor into a scalar Calibration Confidence Score (CCS) expressed as a probability P (in-spec) that the sensor's current extrinsic parameters remain within manufacturer-defined operational tolerance.

The CCS is computed using a calibrated scoring function f, nominally a logistic regression model or a small, gradient-boosted ensemble classifier, that maps a seven-dimensional evidence vector to a probability value in [0, 1]. The seven evidence dimensions are: (1) the Displacement Risk Score DRS[s] (FIGS. 2, 142) from Module 1; (2) the systematic reprojection residual magnitude σ_sys; (3) the systematic-to-random ratio R; (4) the road-feature-based vanishing point deviation Δθ_vp; (5) the evidence frame count N_frames; (6) the scene quality index Q_scene; and (7) the sensor type and structural coupling classification from the SVP.

The scoring function f is trained using a labeled dataset of simulated and empirically measured displacement scenarios, where ground-truth displacement is established by controlled mechanical adjustment of sensor mounts to known angles and the resulting evidence vectors are recorded. The function is validated against a held-out dataset to verify calibration—that that is, that the output probabilities accurately reflect the true empirical frequency of sensors being in-specification at each output value. The trained function is stored as a compact serialized model in the non-volatile storage module 500 and is updateable via OTA firmware update as field data improves model accuracy over the vehicle's operational life.

The CCS output is classified into three authority bands 160: PASS (CCS≥0.85), ADVISORY (0.60≤CCS<0.85), and FAIL (CCS<0.60). The PASS band represents high confidence that the sensor is within calibration tolerance and permits full restoration of ADAS authority for features dependent on this sensor. The ADVISORY band represents moderate uncertainty and permits ADAS features to be available at reduced authority with driver notification. The FAIL band represents high probability of out-of-tolerance displacement and results in disablement of ADAS features dependent on this sensor pending professional recalibration.

FIG. 5 shows Module 4's Autonomous Authority Gating Module 162 applying the CCS vector to govern ADAS feature availability at re-ignition. Each ADAS feature in the vehicle's feature set is associated with a dependency vector specifying which sensors are required for its safe operation, and the minimum CCS band required from each. The dependency mapping for the preferred embodiment six-sensor platform is: AEB Forward requires Fwd Camera (S1) PASS and Fwd RADAR (S2) PASS or ADVISORY; LKA requires Fwd Camera (S1) not FAIL; Hands-free Highway Mode requires Fwd Camera (S1) PASS and Fwd RADAR (S2) PASS; Adaptive Cruise Control (ACC) requires Fwd RADAR (S2) not FAIL; BSW requires both Rear-Lateral RADARs (S4, S5) not FAIL.

Module 4 evaluates the CCS for each sensor in each feature's dependency vector and applies the most restrictive CCS classification among the dependency set as the feature's effective authority level. A feature whose dependency set includes any FAIL-band sensor is disabled regardless of the status of other sensors in its dependency set.

In normal operation 164, the ADAS is given full authority over sensors. When an impact is detected 166, the system moves into “provisional restriction,” flagging high-risks sensors and suspeding hands-free mode. After the vehicle is restarted, the system moves into verification mode 168, giving a PASS/ADVISORY/FAIL state 170, a Professional Recalibration Clearance 172, and Authority Restored states 174, with transition conditions and HMI notification triggers.

FIG. 6 shows a representative HMI driver display 178 with the post-impact recalibration status summary as presented to the driver following Module-4 processing. This summary includes status indicators for each sensor; CCS values; reprojection residual measurements; and the ADAS feature availability summary derived from the feature-to-sensor dependency mapping.

Upon completion of the Module-3 scoring computation, Module 4 formats and presents a structured recalibration status summary 178 to the driver through the vehicle's HMI at the next ignition cycle following the verification observation window. The summary 178 presents: (a) notification that an impact event was detected, with the date and estimated severity; (b) a per-sensor status display showing the sensor type, location, CCS value, and PASS/ADVISORY/FAIL classification (FIGS. 4, 160) for each sensor in the High-Risk queue; (c) the key evidence metric (reprojection residual magnitude (FIGS. 4, 158) and systematic-to-random ratio) supporting each classification; and (d) a plain-language ADAS feature availability summary identifying which features are fully available, which are available at reduced authority, and which are disabled pending professional recalibration.

When any sensor receives an ADVISORY or FAIL classification, Module 4 additionally generates a structured service notification comprising the vehicle identification number, the date and approximate severity of the impact event, the identity of each affected sensor, and the CCS classification for each. This notification is transmitted to the vehicle's telematics channel (FIGS. 5, 176) for delivery to the OEM, authorized dealer network, and optionally the owner's insurance carrier. The service notification supports prioritized scheduling of calibration service visits and provides insurers with an objective record of calibration-relevant events that predated any ADAS-related insurance claim.

A professional calibration clearance signal (FIGS. 5, 172), received through the vehicle's OBD-II diagnostic interface or via a secure OTA channel from an authorized calibration facility, resets the CCS for the identified sensor to 1.0 (PASS), clears any FAIL or ADVISORY restriction (FIGS. 5, 176), on features dependent on that sensor, and records the clearance event in the tamper-evident event log. This log includes the calibration facility identifier, technician credentials, and calibration-procedure identifier. The clearance event is cryptographically signed using the calibration facility's authorized certificate, enabling the OEM and regulatory authorities to verify authenticity of clearance events in post-incident analysis.

FIG. 7 shows sensor locations from top 180 and side 182 views.

In an embodiment, a forward-facing long-range RADAR, two rear-lateral short-range RADAR units, and a rear-facing camera, Module 2 performs a RADAR-to-camera reprojection consistency analysis using the forward camera-RADAR pair 180, and a lane-marking-based, vanishing-point analysis. Module 3 outputs CCS values for each of the five sensors in this configuration. Module 4 governs AEB forward, LKA, ACC, and BSW authority, based on the CCS vector, using the dependency mapping described above. This embodiment requires no LiDAR and is compatible with mass-market ADAS compute platforms, requiring an estimated additional five percent of available compute budget for the Module 2 and Module 3 processing at 10-frames-per-second operation. This embodiment is suitable for mass-market vehicles equipped with a forward-facing monocular cameras.

A second embodiment, for vehicles equipped with a LiDAR sensor and the camera-RADAR, performs LiDAR-to-camera surface normal consistency analysis as a third verification channel for the forward-facing sensor cluster. The CCS for the forward camera and LiDAR sensors is enriched by this additional, independent evidence channel, improving confidence-scoring reliability in low-texture road environments, and at night where lane-marking-based analysis gives limited evidence. The LiDAR adds an independent SVP entry with directional sensitivity coefficients appropriate to its roof-mount or A-pillar mount.

In a third embodiment, the SVP database is stored in an updateable partition of the computer, configurable via over-the-air firmware update through the vehicle's secure OTA update channel. This enables the OEM to refine sensitivity coefficient values based on field data accumulated from the deployed vehicle fleet—for example, discovering that a particular sensor mounting configuration on a specific vehicle model exhibits higher observed displacement rates under low-speed rear impacts than the initial design-stage sensitivity coefficient predicted. Fleet-level refinement of SVP coefficients improves DRS computation accuracy over the model lifecycle and can be delivered without requiring a service visit.

In a fourth embodiment, the structured service notification generated by Module 4 is transmitted to the vehicle's insurance telematics platform, giving the insurer an objective, cryptographically authenticated record of each calibration-relevant impact event, its severity, the affected sensors, and the resulting CCS classifications. This embodiment enables insurance carriers to correlate ADAS-related claim incidents with the calibration history of the vehicle at the time of the incident, enabling data-driven adjustments to ADAS-related risk pricing and providing an objective basis for claim adjudication where the calibration status of the vehicle at the time of an incident is material to liability assessment.

1. An automated system for managing advanced driver assistance systems (ADAS) in a vehicle following a low-impact collision, the system comprising:
a sensor network comprising at least one inertial measurement unit (IMU) and
a plurality of ADAS sensors; and
a non-volatile storage module; and
a domain controller having at least one processor configured to execute instructions to:
monitor acceleration data from the IMU to detect an impact event having a peak acceleration that exceeds a lower-trigger threshold and falls below an upper airbag-deployment threshold; and
compute a displacement risk score for each of the plurality of ADAS sensors based at least in part on the acceleration data; and
classify at least one ADAS sensor as a high-risk sensor if its corresponding displacement risk score exceeds a configurable risk threshold; and
execute, following a subsequent vehicle ignition cycle, an autonomous calibration verification routine during vehicle operation to calculate a calibration confidence score for the high-risk sensor, wherein the verification routine utilizes natural environmental scenes observed by the sensor network; and
restrict or restore operational authority of specific ADAS features based on the calculated calibration confidence score.

2. The system of claim 1 wherein:
computing the displacement risk score further comprises determining an impact-direction vector from the acceleration data and multiplying said impact-direction vector against a pre-stored structural vulnerability profile associated with each respective ADAS sensor.

3. The system of claim 2 wherein:
the structural vulnerability profile for each ADAS sensor comprises a sensor mounting location, a sensor type, a structural-coupling classification, and a directional sensitivity coefficient vector.

4. The system of claim 1 wherein:
the autonomous calibration verification routine comprises a cross-sensor reprojection-consistency analysis that compares data between at least two overlapping sensors in the sensor network to detect systematic reprojection residuals.

5. The system of claim 1 wherein:
the autonomous calibration verification routine comprises a road-feature-based extrinsic verification that assesses sensor alignment using detected lane markings and vanishing-point geometry.

6. The system of claim 1 wherein:
the domain controller limits the autonomous calibration verification routine to a bounded observation window defined by a maximum driving distance or a maximum elapsed driving time from vehicle ignition, during which ADAS features dependent on the high-risk sensor operate under provisional authority restrictions.

7. The system of claim 1 wherein:
restricting or restoring operational authority comprises classifying the calibration confidence score into one of three bands:
a pass band that fully restores dependent ADAS features; and
an advisory band that restores dependent ADAS features at a reduced authority level and triggers a driver notification; or
a fail band that disables dependent ADAS features.

8. The system of claim 1 wherein:
the domain controller is further configured to record the impact event, an impact-severity classification, an impact-direction vector, and the calculated displacement risk score for each ADAS sensor into a tamper-evident event log utilizing an append-only cryptographic hash chain.

9. A method for managing advanced driver assistance systems (ADAS) in a vehicle following a low-impact collision, the method comprising:
continuously monitoring, via a computing device, data from an inertial measurement unit (IMU) to detect a vehicular impact event; and
determining that the impact event comprises a peak acceleration delta exceeding a lower-trigger threshold but remaining below an upper airbag-deployment threshold; and
calculating an impact-direction vector from the IMU data; and
determining a displacement risk score for each ADAS sensor on the vehicle by analyzing the peak acceleration delta, the impact-direction vector, and a structural vulnerability profile unique to each ADAS sensor; and
identifying a high-risk sensor based on the displacement risk score; and
accumulating verification evidence for the high-risk sensor utilizing natural scene data gathered during dynamic vehicle operation; and
computing a calibration confidence score for the high-risk sensor by determining a systematic-to-random ratio of sensor alignment residuals from the accumulated verification evidence; and
gating autonomous authority of vehicle ADAS features based on a dependency mapping linking specific ADAS features to the calculated calibration confidence score of the high-risk sensor.

10. The method of claim 9 further comprising:
automatically transmitting a structured service notification to a telematics channel if the calibration confidence score falls below a predefined pass threshold, wherein the notification includes a vehicle identification number, an estimated severity of the impact event, and the identity of the high-risk sensor.
